(19) United States
(12) Patent Application Publication
(10) Pub. No.: US 2008/0096551 A1
(43) Pub. Date: Apr. 24, 2008

(54) Cell phone apparatus having wireless mouse function

(76) Inventor: Yu-Sheng Huang, Tainan County (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/585,375

(22) Filed: Oct. 24, 2006

(51) Int. Cl. H04Q 7/20

(52) U.S. Cl. 455/425

(57) ABSTRACT

A cell phone apparatus includes a plurality of computers each having a first wireless transmission device, and a cell phone having a second wireless transmission device connected to the first wireless transmission device of each of the computers. The cell phone has a back face provided with a sensor exposed outwardly so that the cell phone functions as a wireless mouse by operation of the sensor. Thus, the cell phone functions as a wireless mouse of a specified notebook or table computer without having to provide a mouse additionally, thereby facilitating a user operating the computer by the wireless mouse function provided by the cell phone.

### BACKGROUND OF THE INVENTION

1. Field of the Invention

The present invention relates to a cell phone apparatus and, more particularly, to a cell phone apparatus having a wireless mouse function.

2. Description of the Related Art

A conventional cell phone apparatus having a mouse function comprises a cell phone, at least one mouse function key, a displacement detection module, and a transmission interface. The transmission interface transmits the signals of the movement distance and direction of the cell phone into a computer and transmits the operation signals of mouse function key into the computer, so that the cell phone functions as a mouse of the computer. However, the cell phone is only available for a specified computer and is not available other computers, thereby limiting the versatility of the cell phone apparatus.

### BRIEF SUMMARY OF THE INVENTION

In accordance with the present invention, there is provided a cell phone apparatus, comprising a plurality of computers each having an inside containing a first wireless transmission device, and a cell phone having an inside containing a second wireless transmission device connected to the first wireless transmission device of each of the computers.

The primary objective of the present invention is to provide a cell phone apparatus having a wireless mouse function.

Another objective of the present invention is to provide a cell phone apparatus, wherein the cell phone functions as a wireless mouse to operate a computer, thereby enhancing the versatility of the cell phone.

A further objective of the present invention is to provide a cell phone apparatus, wherein the cell phone functions as a wireless mouse of a specified notebook or table computer without having to provide a mouse additionally, thereby facilitating a user operating the computer by the wireless mouse function provided by the cell phone.

A further objective of the present invention is to provide a cell phone apparatus, wherein the cell phone recognizes the information of a specified one of the computers, so that only the specified one of the computers is manipulated by the cell phone to prevent the cell phone from interfering with operation of the computers.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a cell phone apparatus in accordance with the preferred embodiment of the present invention.

FIG. 2 is a perspective view of a cell phone of the cell phone apparatus as shown in FIG. 1.

FIG. 3 is a plan view of the cell phone apparatus as shown in FIG. 1.

FIG. 4 is a flow chart of operation of the cell phone apparatus as shown in FIG. 1.

### DETAILED DESCRIPTION OF THE INVENTION

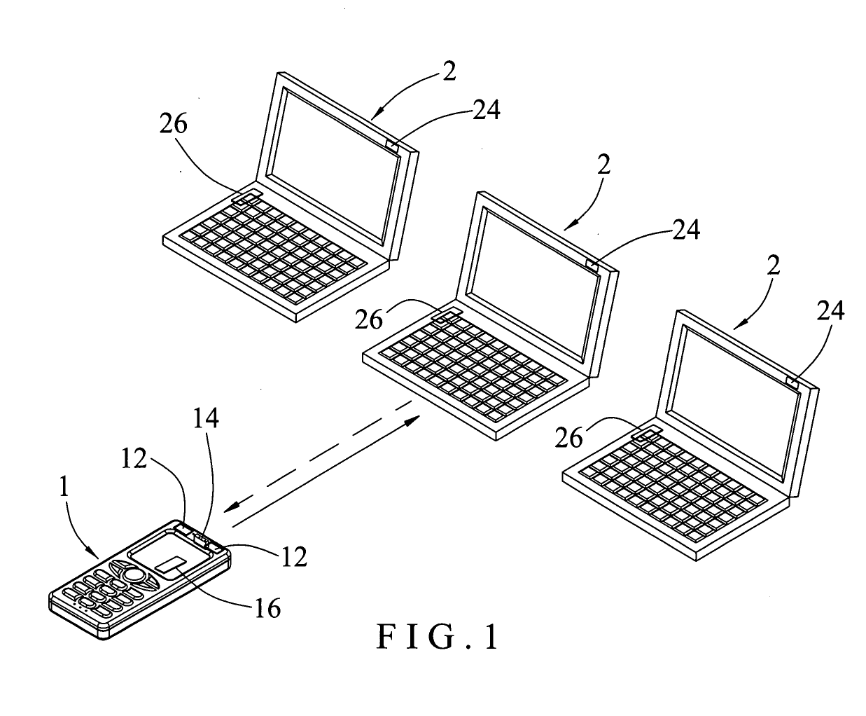

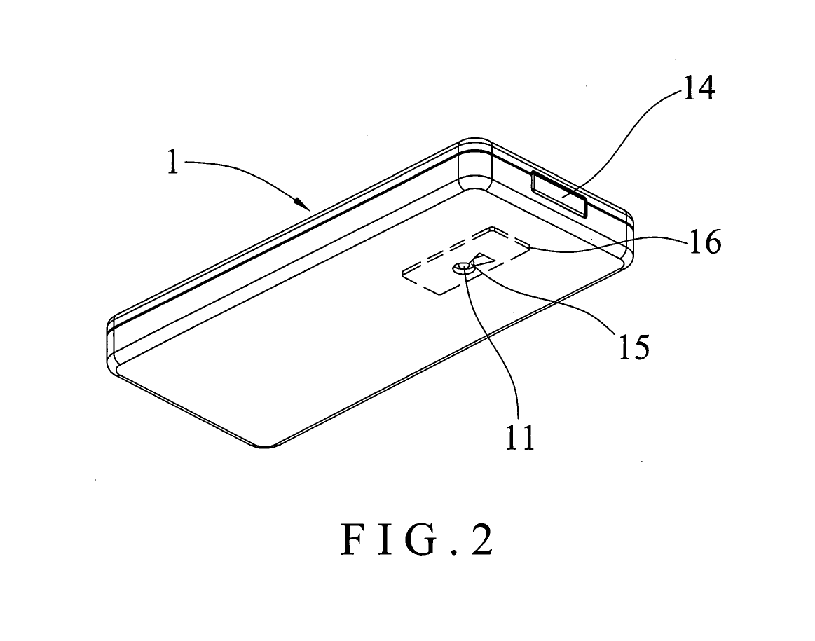

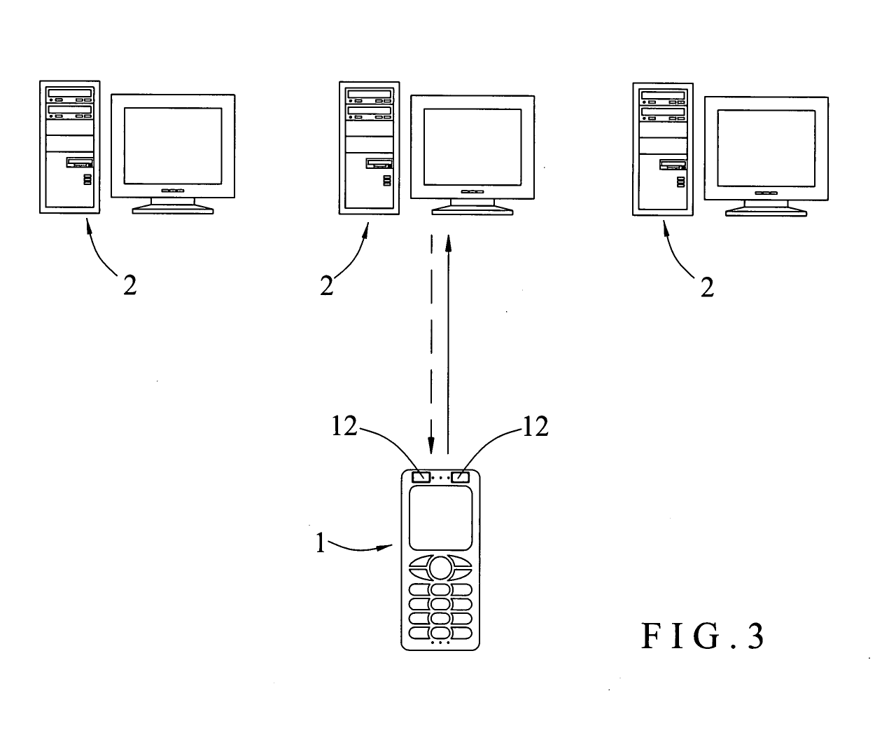

Referring to the drawings and initially to FIGS. 1-3, a cell phone apparatus in accordance with the preferred embodiment of the present invention comprises a plurality of computers 2 each having an inside containing a first wireless transmission device 24, and a cell phone 1 having an inside containing a second wireless transmission device 14 connected to the first wireless transmission device 24 of each of the computers 2.

Each of the computers 2 is preferably a notebook computer or a table computer. The inside of each of the computers 2 also contains a first drive program 26. The inside of the cell phone 1 also contains a second drive program 16. The second wireless transmission device 14 of the cell phone 1 detects existence of the first wireless transmission device 24 of each of the computers 2 in a determined field to receive and transmit information of each of the computers 2 from the first wireless transmission device 24 of each of the computers 2 into the cell phone 1. The information of each of the computers 2 includes a user name, code, serial number and the like. The cell phone 1 recognizes the information of a specified one of the computers 2, so that only the specified one of the computers 2 is manipulated by the cell phone 1 to prevent the cell phone 1 from interfering with operation of the computers 2. The cell phone 1 has a back face provided with a sensor 11 exposed outwardly from the back face of the cell phone 1 so that the cell phone 1 functions as a wireless mouse by operation of the sensor 11. The back face of the cell phone 1 is formed with an opening 15 to expose the sensor 11. The cell phone 1 has a front face provided with at least one operation button 12 that is pressed to operate the specified one of the computers 2.

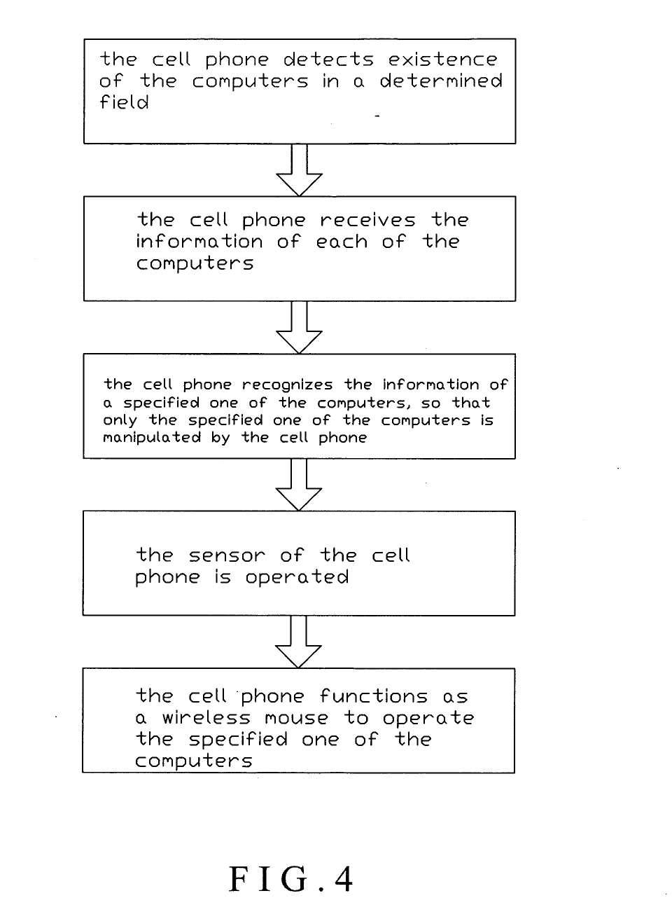

In operation, referring to FIGS. 1-4, the cell phone apparatus is operated as follows. First of all, the second wireless transmission device 14 of the cell phone 1 detects existence of the first wireless transmission device 24 of each of the computers 2 in a determined field. Then, the second wireless transmission device 14 of the cell phone 1 receives and transmits the information of each of the computers 2 from the first wireless transmission device 24 of each of the computers 2 into the cell phone 1. Then, the cell phone 1 recognizes the information of a specified one of the computers 2, so that only the specified one of the computers 2 is manipulated by the cell phone 1 to prevent the cell phone 1 from interfering with operation of the computers 2. Then, the sensor 11 of the cell phone 1 is operated and directed downward toward a plane, such as a table, so that the cell phone 1 functions as a wireless mouse by operation of the sensor 11. Finally, the operation button 12 of the cell phone 1 is pressed to operate the specified one of the computers 2, so that the cell phone 1 functions as a wireless mouse to operate the specified one of the computers 2.

Accordingly, the cell phone 1 functions as a wireless mouse to operate a computer, thereby enhancing the versatility of the cell phone 1. In addition, the cell phone 1 functions as a wireless mouse of a specified notebook or table computer without having to provide a mouse additionally, thereby facilitating a user operating the computer by the wireless mouse function provided by the cell phone 1. Further, the cell phone 1 recognizes the information of a specified one of the computers 2, so that only the specified one of the computers 2 is manipulated by the cell phone 1 to prevent the cell phone 1 from interfering with operation of the computers 2.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A cell phone apparatus, comprising:
a plurality of computers each having an inside containing a first wireless transmission device;
a cell phone having an inside containing a second wireless transmission device connected to the first wireless transmission device of each of the computers.

2. The cell phone apparatus in accordance with claim 1, wherein the inside of each of the computers contains a first drive program.

3. The cell phone apparatus in accordance with claim 2, wherein the inside of the cell phone also contains a second drive program.

4. The cell phone apparatus in accordance with claim 1, wherein the second wireless transmission device of the cell phone detects existence of the first wireless transmission device of each of the computers in a determined field to receive and transmit information of each of the computers from the first wireless transmission device of each of the computers into the cell phone.

5. The cell phone apparatus in accordance with claim 4, wherein the information of each of the computers includes a user name, code and serial number.

6. The cell phone apparatus in accordance with claim 4, wherein the cell phone recognizes the information of a specified one of the computers, so that only the specified one of the computers is manipulated by the cell phone to prevent the cell phone from interfering with operation of the computers.

7. The cell phone apparatus in accordance with claim 1, wherein the cell phone has a back face provided with a sensor exposed outwardly from the back face of the cell phone so that the cell phone functions as a wireless mouse by operation of the sensor.

8. The cell phone apparatus in accordance with claim 7, wherein the back face of the cell phone is formed with an opening to expose the sensor.

9. The cell phone apparatus in accordance with claim 1, wherein the cell phone has a front face provided with at least one operation button that is pressed to operate the specified one of the computers.

10. The cell phone apparatus in accordance with claim 6, wherein the cell phone functions as a wireless mouse to operate the specified one of the computers.
